(19) United States
(12) Patent Application Publication
(10) Pub. No.: US 2025/0350071 A1
(43) Pub. Date: Nov. 13, 2025

(54) WIRE-AND-OUTER CONDUCTOR CRIMPING STRUCTURE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yusuke KOJIMA, Osaka (JP); Kazuaki HAMADA, Osaka (JP)

(21) Appl. No.: 18/870,392

(22) PCT Filed: May 9, 2023
(86) PCT No.: PCT/JP2023/017435

§ 371 Date: Nov. 28, 2024

(30) Foreign Application Priority Data
May 30, 2022 (JP) 2022-087730

(51) Int. Cl. H01R 13/6592; H01R 4/18

(52) U.S. Cl. CPC H01R 13/6592; H01R 4/183

(57) ABSTRACT

A crimping portion of an outer conductor includes a first crimp portion cantilevered in one circumferential direction from a base plate portion and surrounding a shielded cable, a second crimp portion cantilevered in the other circumferential direction from a position forward of the first crimp portion in the base plate portion and surrounding the shielded cable, a first locking portion provided by folding a tip part of the first crimp portion inward, a second locking portion provided by folding a tip part of the second crimp portion inward, and a restricting portion cantilevered backward in an axial direction of the shielded cable. The second locking portion faces an end edge of the restricting portion on one circumferential side. The first locking portion faces an end edge of the restricting portion on the other circumferential side behind the second locking portion in the axial direction.

### TECHNICAL FIELD

The present disclosure relates to a wire-and-outer conductor crimping structure.

### BACKGROUND

Patent Document 1 discloses a wire crimping structure to be crimped to an end part of a shielded cable by a first crimp portion and a second crimp portion provided in an upper shell. This structure can suppress a crimping portion from being opened in a circumferential direction even if a terminal is pulled in an axial direction of the cable.

### PRIOR ART DOCUMENT

### Patent Document

Patent Document 1: JP 2019-029204 A

### SUMMARY OF THE INVENTION

### Problems to be Solved

In the crimping structure of Patent Document 1, a restricting portion may be inclined in the circumferential direction due to a shift of a timing at which base end parts of the first and second crimp portions contact both end edges in the circumferential direction of the restricting portion when the crimping portion is crimped. If the restricting portion is inclined in the circumferential direction away from the base end of the crimp portion located on the tip of the restricting portion, there has been a concern that a locking portion of this crimp portion rides on the restricting portion and cannot lock. The inclination of this restricting portion is thought to be eliminated by eliminating a clearance provided between the crimping portion and a jig, on which the crimping portion is placed when the crimping portion is crimped, and suppressing a play of the crimping portion relative to the jig. However, considering dimensional variations of components, it is not realistic to eliminate the clearance. Thus, it is difficult to completely suppress the inclination of the restricting portion. Therefore, a method for locking the locking portion of the crimp portion to the restricting portion even if the restricting portion is inclined has been desired.

The present disclosure was completed on the basis of the above situation and aims to prevent the opening of a crimping portion.

### Means to Solve the Problem

The present disclosure is directed to a wire-and-outer conductor crimping structure, comprising a crimping portion in the form of an open barrel provided on an outer conductor to be connected to an end part of a wire, the crimping portion being crimped to an outer periphery of the wire, the crimping portion including a base plate portion arranged along the outer periphery of the wire, a first crimp portion cantilevered in one circumferential direction of the wire from the base plate portion, the first crimp portion being crimped to surround the outer periphery of the wire, a second crimp portion cantilevered in the other circumferential direction from a position forward of the first crimp portion in the base plate portion, the second crimp portion being crimped to surround the outer periphery of the wire, a first locking portion provided by folding a tip part in the circumferential direction of the first crimp portion inward, a second locking portion provided by folding a tip part in the circumferential direction of the second crimp portion inward, and a restricting portion cantilevered backward in an axial direction of the wire along the outer periphery of the wire, the restricting portion being covered by the first and second crimp portions, the second locking portion facing an end edge of the restricting portion on one circumferential side in the circumferential direction, the first locking portion facing an end edge of the restricting portion on the other circumferential side in the circumferential direction behind the second locking portion in the axial direction, and a width in the circumferential direction of a first part facing the first locking portion, out of the restricting portion, being set to be smaller than a width in the circumferential direction of a second part facing the second locking portion, out of the restricting portion.

### Effect of the Invention

According to the present disclosure, the opening of a crimping portion can be prevented.

### BRIEF DESCRIPTION OF THE DRAWINGS

FIG. 1 is a perspective view of a shield conductive path of one embodiment.

FIG. 2 is a plan view in section of the shield conductive path of the embodiment.

FIG. 3 is a perspective view of an upper shell of the embodiment.

FIG. 4 is a back view of the upper shell of the embodiment.

FIG. 5 is a section along A-A in FIG. 2.

FIG. 6 is a perspective view of a lower shell of the embodiment.

FIG. 7 is a plan view enlargedly showing a main part of a restricting portion of the lower shell of the embodiment.

FIG. 8 is a plan view enlargedly showing a main part of the crimped crimping portion.

FIG. 9 is a plan view enlargedly showing a main part of the crimped crimping portion with the restricting portion inclined.

### DETAILED DESCRIPTION TO EXECUTE THE INVENTION

### Description of Embodiments of Present Disclosure

First, embodiments of the present disclosure are listed and described.

The wire-and-outer conductor crimping structure of the present disclosure is as follows: (1) The wire-and-outer conductor crimping structure of the present disclosure is provided with a crimping portion in the form of an open barrel provided on an outer conductor to be connected to an end part of a wire, the crimping portion being crimped to an outer periphery of the wire. The crimping portion includes a base plate portion, a first crimp portion, a second crimp portion, a first locking portion, a second locking portion and a restricting portion. The base plate portion is arranged along the outer periphery of the wire. The first crimp portion is cantilevered in one circumferential direction of the wire from the base plate portion and crimped to surround the outer periphery of the wire. The second crimp portion is cantilevered in the other circumferential direction from a position forward of the first crimp portion in the base plate portion and crimped to surround the outer periphery of the wire. The first locking portion is provided by folding a tip part in the circumferential direction of the first crimp portion inward. The second locking portion is provided by folding a tip part in the circumferential direction of the second crimp portion inward. The restricting portion is cantilevered backward in an axial direction of the wire along the outer periphery of the wire and covered by the first and second crimp portions. The second locking portion faces an end edge of the restricting portion on one circumferential side in the circumferential direction. The first locking portion faces an end edge of the restricting portion on the other circumferential side in the circumferential direction behind the second locking portion in the axial direction. A width in the circumferential direction of a first part facing the first locking portion, out of the restricting portion, is set to be smaller than a width in the circumferential direction of a second part facing the second locking portion, out of the restricting portion.

According to this configuration, a displacement amount of the restricting portion is larger on a back side than on a front side. According to the present disclosure, the width in the circumferential direction of the first part facing the first locking portion, out of the restricting portion, is set to be smaller than that of the second part facing the second locking portion, out of the restricting portion. Thus, even if a back end part of the restricting portion having a larger displacement amount than a front end is inclined in a direction toward the first locking portion, it is possible to prevent a situation where the first locking portion rides on the restricting portion and cannot lock.

(2) Preferably, an end edge of the first part on a side facing the first locking portion in the circumferential direction is arranged to be stepped to approach an end edge on a side facing the second locking portion with respect to an end edge of the second part on the side facing the first locking portion. According to this configuration, even if the restricting portion is inclined in the direction toward the first locking portion, the situation where the first locking portion rides on the restricting portion and cannot lock can be prevented by a simple configuration of forming the second part and the first part into a stepped shape.

(3) Preferably, in (2), the width in the circumferential direction of the first part is larger than half the width in the circumferential direction of the second part. According to this configuration, the strength of the first part can be ensured and the deformation of this part can be prevented.

(4) Preferably, a back end part of the first part projects further backward than the first locking portion. According to this configuration, since the first locking portion can entirely face the end edge of the first part in the axial direction, the first locking portion can reliably lock the first part.

(5) Preferably, a dimension of the first locking portion is smaller than that of the second locking portion in the circumferential direction. According to this configuration, a dimension between the first locking portion and the first part in the circumferential direction can be made larger than a dimension between the second locking portion and the second part in the circumferential direction. Thus, even if the restricting portion is inclined in the direction toward the first locking portion, it is possible to prevent the situation where the first locking portion rides on the restricting portion and cannot lock.

### Embodiment

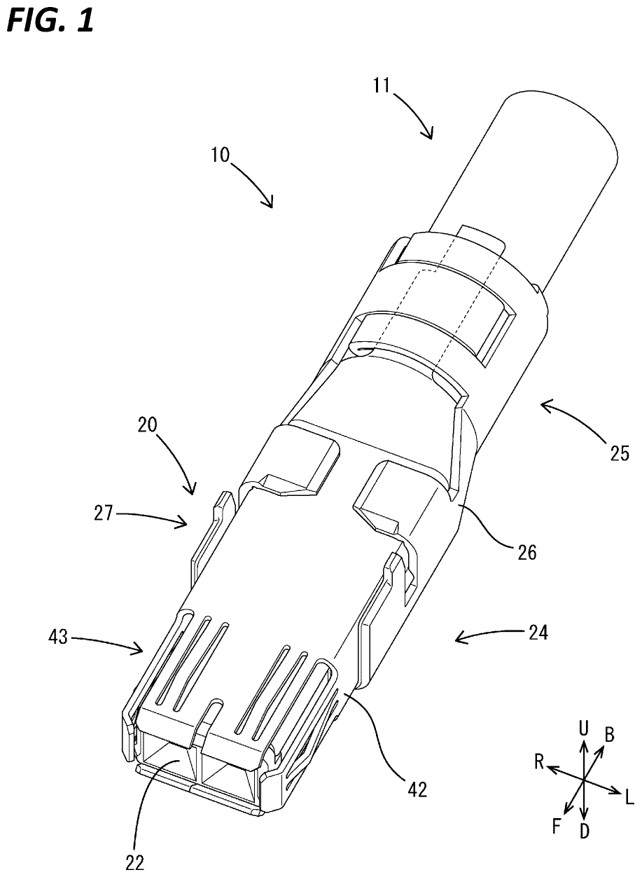

A specific embodiment of the present disclosure is described below with reference to FIGS. 1 to 9. In figures, a “front side”, a “back side”, an “upper side”, a “lower side”, a “right side” and a “left side” are respectively represented by “F”, “B”, “U”, “D”, “R” and “L”. Note that circumferential directions in this embodiment include both a clockwise direction and a counterclockwise direction about an axis when a shielded cable 11 is viewed from behind in an axial direction.

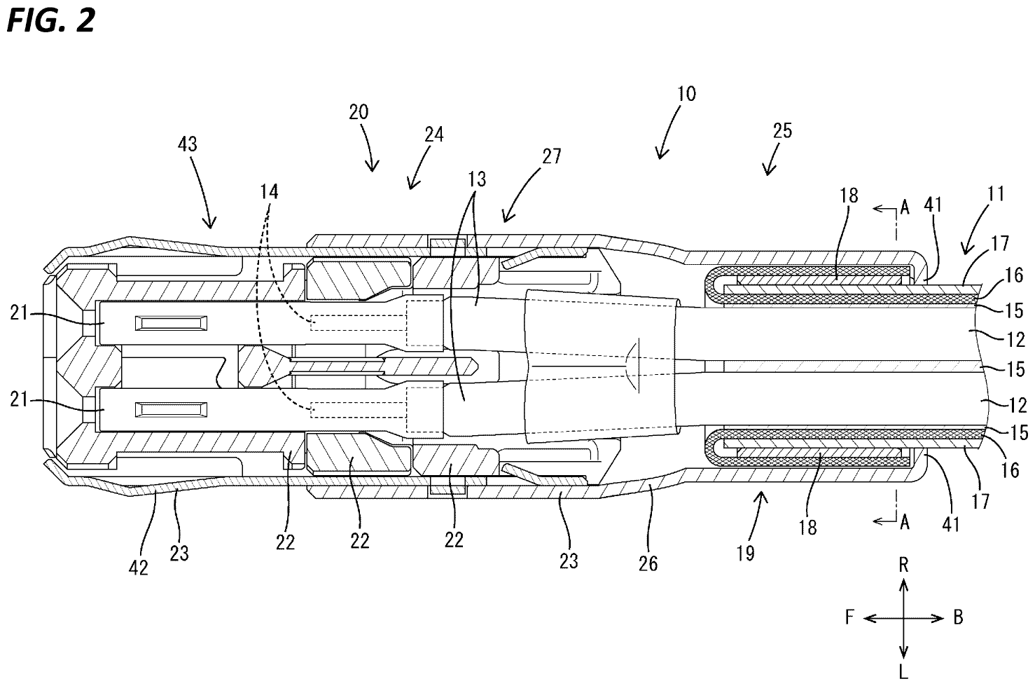

A wire-and-outer conductor crimping structure of this embodiment is applied to a shield conductive path 10. As shown in FIG. 1, the shield conductive path 10 is formed such that a shield terminal 20 is fixed to a front end part of the shielded cable 11, which is a wire. As shown in FIG. 2, the shielded cable 11 is such that a plurality of (two in this embodiment) coated wires 12 are embedded in an insulator 15 having a circular cross- section, the outer periphery of the insulator 15 is surrounded by a tubular shield layer 16 made of a braided wire and the shield layer 16 is surrounded by a hollow cylindrical sheath 17. In a front end part of the shielded cable 11, the sheath 17 and the insulator 15 are removed and the plurality of coated wires 12 are exposed in an individually bendable state. An insulation coating 13 is removed in a front end part of each coated wire 12 to expose a front end part of a core wire 14.

A sleeve 18 is crimped to the outer peripheral surface of a front end part of the sheath 17. A front end part of the shield layer 16 is folded backward behind exposed regions of the core wires 14, and the outer peripheries of the sheath 17 and the sleeve 18 are covered by the folded shield layer 16. A region of the shielded cable 11 where the sleeve 18 is crimped is defined as a shield connecting end part 19.

The shield terminal 20 includes inner conductors 21 individually connected to the front end parts of the core wires 14 of the respective coated wires 12, a dielectric 22 accommodating a plurality of the inner conductors 21, and an outer conductor 23 mounted on the dielectric 22 while surrounding the outer periphery of the dielectric 22. That is, the outer conductor 23 is connected to an end part of the shielded cable 11.

The outer conductor 23 is provided with a shell body portion 24 and a crimping portion 25 connected to the back end of the shell body portion 24 (see FIG. 1). That is, the crimping portion 25 is provided in the outer conductor 23. The crimping portion 25 is crimped to the outer periphery of the shield layer 16 of the shielded cable 11. The outer conductor 23 is configured by vertically uniting an upper shell 26 formed, such as by bending a metal plate material, and a lower shell 42 formed, such as by bending a metal plate material.

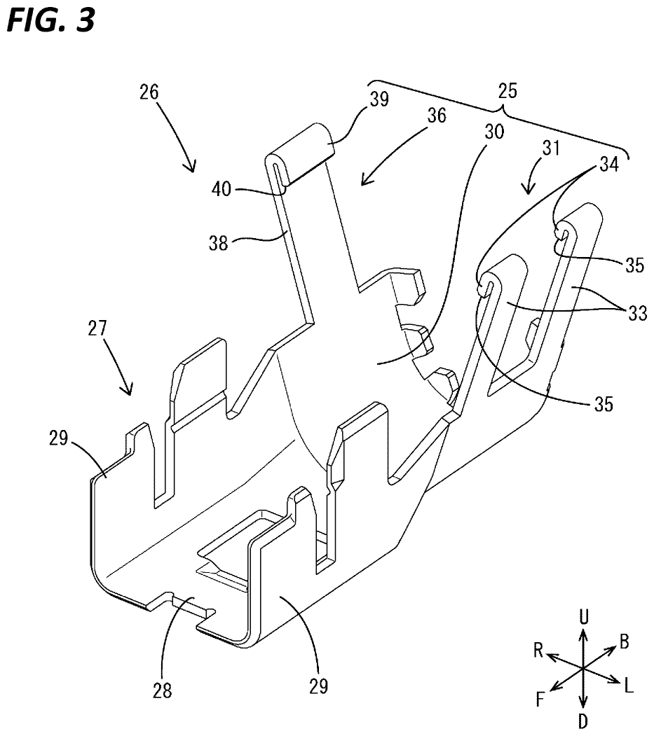

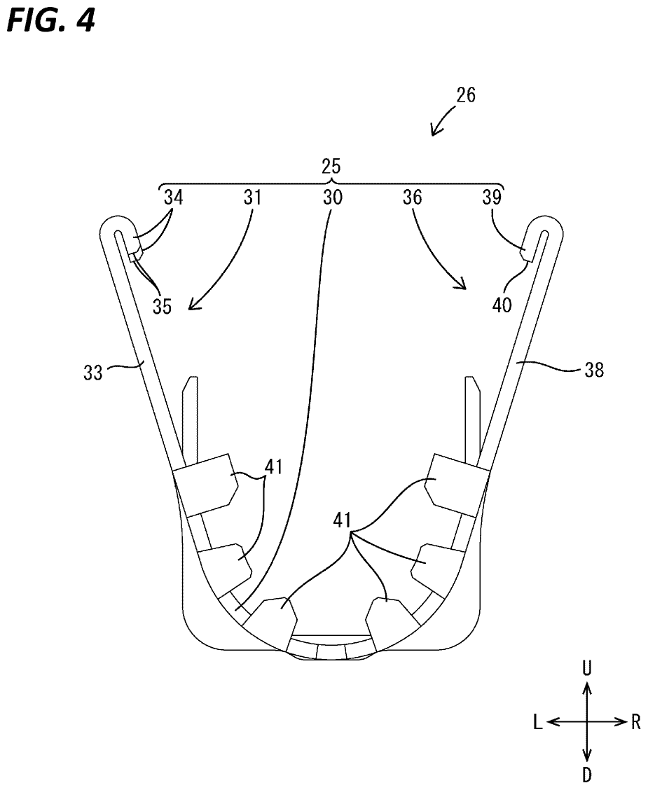

As shown in FIGS. 3 and 4, the upper shell 26 is a single component including the upper shell 27 constituting the shell body portion 24, a base plate portion 30, a first crimp portion 31 and a second crimp portion 36. The upper body portion 27 includes a bottom plate portion 28 and a pair of side plate portions 29 extending upward from both left and right side edges of the bottom plate portion 28.

The base plate portion 30, the first crimp portion 31 and the second crimp portion 36 are constituent elements of the crimping portion 25. That is, the crimping portion 25 includes the base plate portion 30, the first crimp portion 31 and the second crimp portion 36. The base plate portion 30 extends backward from the back end edge of the bottom plate portion 28 and is curved into an arch shape having a lateral central part bulging downward when the crimping portion 25 is viewed from behind (see FIG. 4). That is, the crimping portion 25 is in the form of an open barrel.

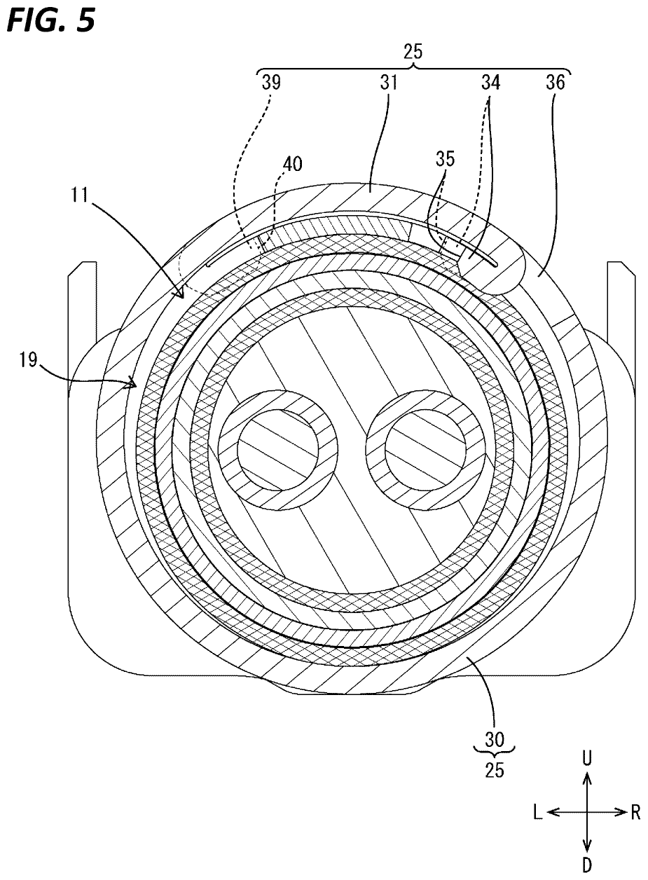

In a state before the crimping portion 25 is crimped to the shielded cable 11, the first crimp portion 31 is in the form of a flat plate extending obliquely to a left upper side from a left side edge part of the base plate portion 30. An extension direction of the first crimp portion 31 is a circumferential direction surrounding the shielded cable 11 in an already crimped state of the crimping portion 25 (see FIG. 5). In other words, the first crimp portion 31 is cantilevered in one circumferential direction of the shielded cable 11 from the base plate portion 30 and crimped to surround the outer periphery of the shielded cable 11.

As shown in FIG. 3, the first crimp portion 31 includes a pair of first extending portions 33 cantilevered from front and back end parts of the base plate portion 30 and extending to be flush with the base plate portion 30. A width (dimension in the axial direction of the shielded cable 11) of one first extending portion 33 is smaller than a width of the base plate portion 30. Each first extending portion 33 has a rectangular shape. An extension dimension (dimension in the circumferential direction orthogonal to an axis of the shielded cable 11) of each rectangular first extending portion 33 from the base plate portion 30 is longer than the width. The positions of the extending tips of the pair of first extending portions 33 are aligned (see FIG. 4).

A first locking portion 34 is provided on each of the extending tips of the pair of first extending portions 33. The first locking portion 34 is formed by bending and folding a tip part in the circumferential direction of the first extending portion 33 of the first crimp portion 31 inward (in a direction toward the axis of the shielded cable 11) (see FIG. 5). The first locking portion 34 is formed over the entire width of the first extending portion 33, and projects inward from the inner surface of the first extending portion 33 by a plate thickness of the first locking portion 34. The extending tip surface of the first locking portion 34 serves as a first locking surface 35 facing the base plate portion 30. In a state before the crimping portion 25 is crimped to the shielded cable 11, a dimension in the extension direction of the first locking portion 34 on the front side is smaller than that of the first locking portion 34 on the back side. The first locking surface 35 of the locking portion 34 on the back side is arranged at a position closer to a base end in the extension direction than the first locking surface 35 of the first locking portion 34 on the front side (see FIG. 4).

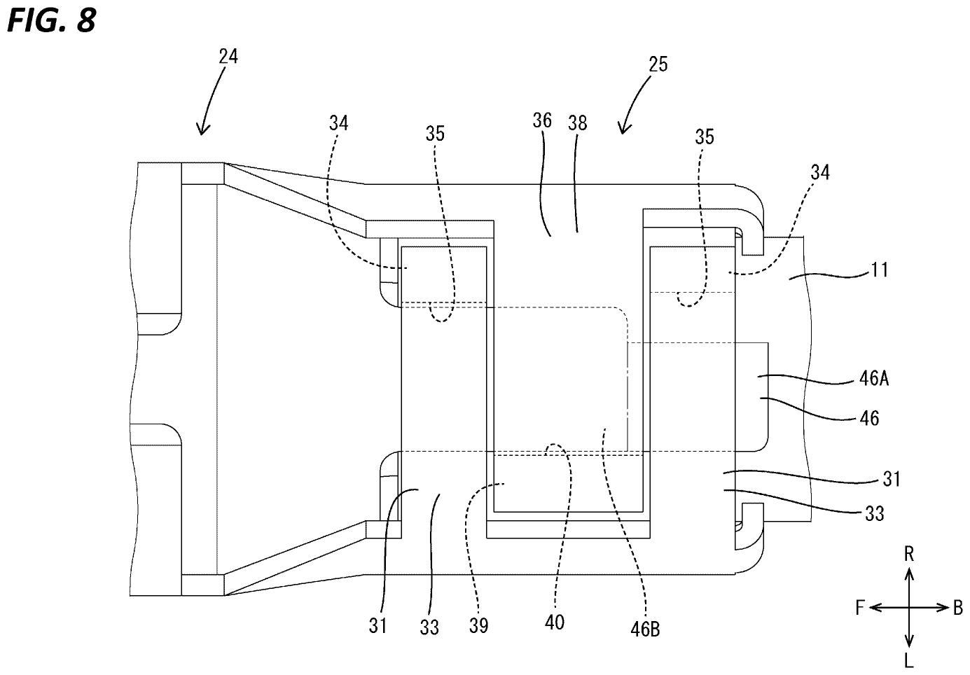

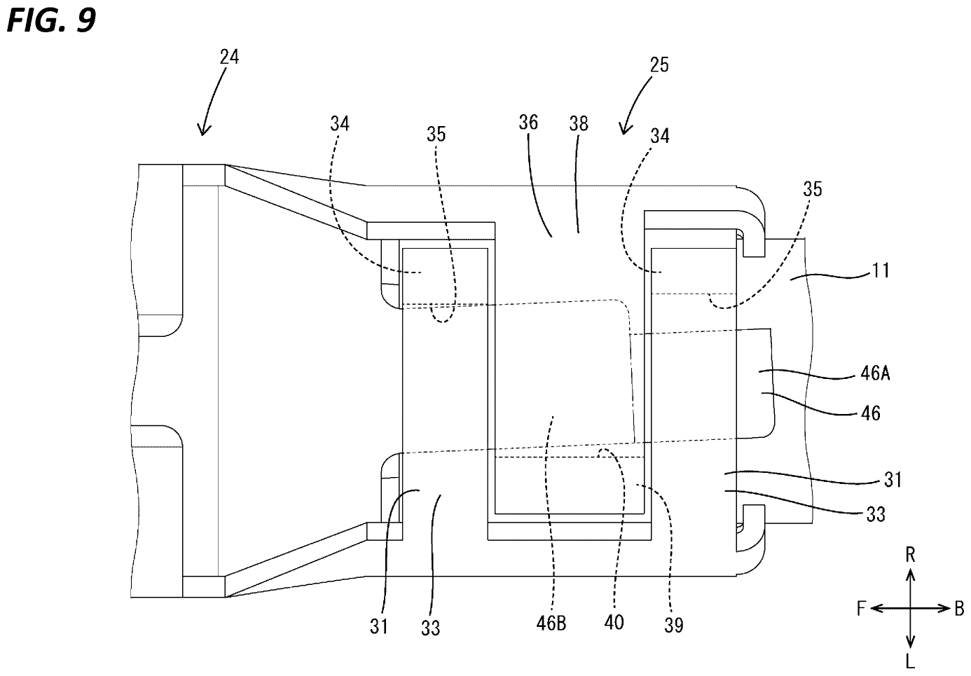

In the state before the crimping portion 25 is crimped to the shielded cable 11, the second crimp portion 36 is in the form of a flat plate extending obliquely to a right upper side from a right side edge part of the base plate portion 30. An extension direction of the second crimp portion 36 is the circumferential direction surrounding the shielded cable 11 in the already crimped state of the crimping portion 25 (see FIG. 5). In other words, the second crimp portion 36 is cantilevered in the other circumferential direction from a position forward of the first crimp portion 31 on the back side in the base plate portion 30, and crimped to surround the outer periphery of the shielded cable 11 (see FIGS. 8 and 9). In the already crimped state of the crimping portion 25, an extension direction of the second crimp portion 36 and that of the first crimp portion 31 are opposite (see FIG. 5). That is, if the crimping portion 25 is viewed from behind in the axial direction of the shielded cable 11, the first crimp portion 31 extends in the clockwise direction from the base plate portion 30, whereas the second crimp portion 36 extends in the counterclockwise direction from the base plate portion 30 (see FIG. 5).

The second crimp portion 36 includes one second extending portion 38 cantilevered from a central part in the front-rear direction of the right end edge of the base plate portion 30. A width (dimension in the axial direction of the shielded cable 11) of the second extending portion 38 is smaller than the width of the base plate portion 30. The second extending portion 38 has a rectangular shape. An extension dimension of the rectangular second extending portion 38 from the base plate portion 30 is longer than the width. The width of the second extending portion 38 is set to be slightly smaller than an interval between the pair of first extending portions 33 (see FIGS. 8 and 9). The width of the second extending portion 38 is equal to the sum of the widths of the pair of first extending portions 33.

A second locking portion 39 is provided on an extending end part of the second extending portion 38. The second locking portion 39 is formed by bending and folding a tip part in the circumferential direction of the second extending portion 38 of the second crimp portion 36 inward (in the direction toward the axis of the shielded cable 11). The second locking portion 39 is formed over the entire width of the second extending portion 38, and projects inward from the inner surface of the second extending portion 38 by a plate thickness of the second locking portion 39. The extending tip surface of the second locking portion 39 serves as a second locking surface 40 facing the base plate portion 30. In the circumferential direction, a dimension of the first locking portion 34 on the back side is smaller than that of the second locking portion 39 (see FIG. 5). The first locking portions 34 and the second locking portion 39 are constituent elements of the crimping portion 25. That is, the crimping portion 25 includes the first locking portions 34 and the second locking portion 39.

A plurality of (six in this embodiment) biting projections 41 are formed on the back end edge of the crimping portion 25 (see FIG. 4). The biting projection 41 is formed by bending a part of a back end edge part of the crimping portion 25 inward (in the direction toward the axis of the shielded cable 11).

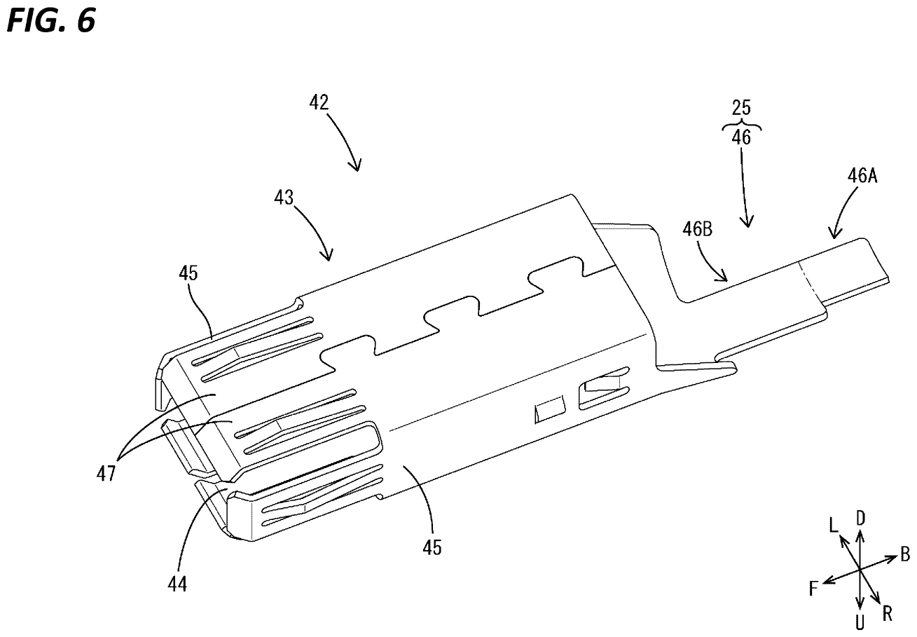

As shown in FIG. 6, the lower shell 42 is a single component including a lower body portion 43 constituting the shell body portion 24 and a restricting portion 46. The lower body portion 43 includes a plate-like upper surface portion 44, a pair of plate-like side surface portions 45 extending downward from both left and right side edges of the upper surface portion 44 and a pair of plate-like bottom surface portions 47 extending laterally inward from the lower end edges of the respective side surface portions 45. The restricting portion 46 is cantilevered backward from the back end edge of the upper surface portion 44. The restricting portion 46 is a constituent element of the crimping portion 25. That is, the crimping portion 25 includes the restricting portion 46.

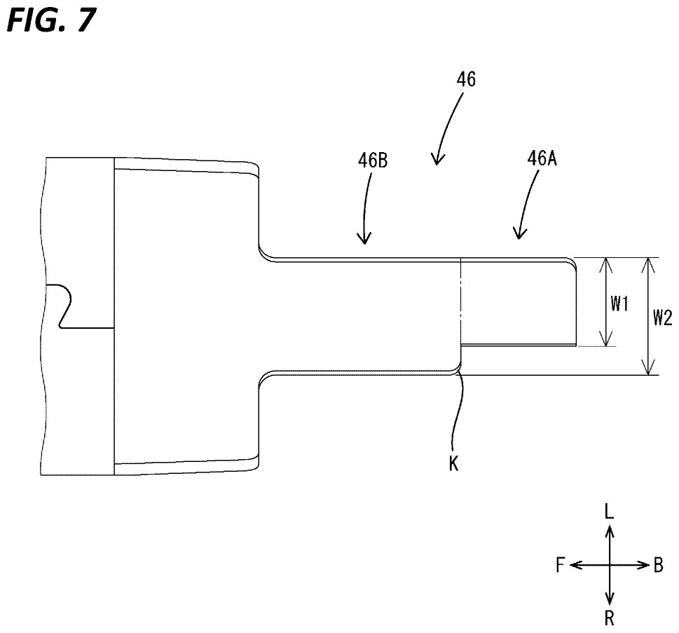

As shown in FIG. 7, the restricting portion 46 includes a first part 46A and a second part 46B located in front of the first part 46A. A width W1 in the circumferential direction of the first part 46A is set to be smaller than a width W2 in the circumferential direction of the second part 46B. The width W1 in the circumferential direction of the first part 46A is larger than half the width W2 in the circumferential direction of the second part 46B. The restricting portion 46 is formed to have a stepped plan view shape by cutting off a part of a back side. In an intersecting part of the right and back end edges of the second part 46B, these right and back end edges are coupled by a curved surface K. The right and back end edges of the first part 46 are coupled without via a curved surface.

Next, an assembly of the shield conductive path 10 is described. The upper and lower body portions 27, 43 are united to vertically sandwich the dielectric 22 to configure the shell body portion 24 in the form of a rectangular tube (see FIG. 1). The inner conductors 21, the entire dielectric 22 and the exposed regions of the coated wires 12 are accommodated in the shell body portion 24 (see FIG. 2). In a state where the outer conductor 23 is not crimped to the shielded cable 11, the crimping portion 25 connected to the back end of the shell body portion 24 is located such that the base plate portion 30 and the restricting portion 46 vertically face each other, and the shield connecting end part 19 is arranged between the base plate portion 30 and the restricting portion 46 (see FIG. 5).

In this state, the crimping portion 25 and the shield connecting end part 19 are set in an applicator (not shown) and crimped. In a crimping step, a crimper and an anvil sandwich the crimping portion 25 and the shield connecting end part 19 in the vertical direction and the crimping portion 25 is plastically deformed to surround the shield connecting end part 19 while being reduced in diameter. At this time, the base plate portion 30 is plastically deformed along the outer periphery of the shielded cable 11 (see FIG. 5).

Then, the two first extending portions 33 and the one second extending portion 38 are pressed against the outer surface of the restricting portion 46 while being plastically deformed. At this time, the second extending portion 38 is fit between the two first extending portions 33 (see FIG. 8). The pair of first locking portions 34 are located to the right of the restricting portion 46, and the first locking surfaces 35 and the right side surface of the restricting portion 46 are facing apart from each other (see FIG. 8). The second locking portion 39 is located to the left of the restricting portion 46 and the second locking surface 40 and the left side surface of the restricting portion 46 are facing apart from each other (see FIG. 8).

If the crimping portion 25 is released from sandwiching pressures from the crimper and the anvil, the first and second crimp portions 31, 36 resiliently return in a diameter-expanding direction by springback and the restricting portion 46 resiliently returns radially outward by springback.

When the first crimp portion 31 resiliently returns in the diameter-expanding direction, the first locking portion 34 on the back side is displaced radially outward while being displaced to approach the restricting portion 46 from a right side (other circumferential side) behind the second locking portion 39 in the axial direction. At this time, the restricting portion 46 is displaced radially outward by springback while being kept in contact with the inner surfaces of the first extending portions 33. Then, the first locking surface 35 of the first locking portion 34 on the back side faces the right end edge (end edge on the other circumferential side) of the first part 46A in the restricting portion 46 from the right side (other circumferential side). That is, the first locking surface 35 of the first locking portion 34 faces the right end edge of the first part 46A of the restricting portion 46.

When the second crimp portion 36 resiliently returns in the diameter-expanding direction, the second locking portion 39 is displaced radially outward while being displaced to approach the restricting portion 46 from a left side. At this time, the restricting portion 46 is displaced radially outward by springback while being kept in contact with the inner surface of the second extending portion 38. Then, the second locking surface 40 of the second locking portion 39 faces the left end edge (end edge on one circumferential side) of the second part 46B in the restricting portion 46 from the left side (one circumferential side). That is, the second locking surface 40 of the second locking portion 39 faces the left end edge of the first part 46A of the restricting portion 46.

The restricting portion 46 is cantilevered backward in the axial direction of the shielded cable 11 from the back end of the shell body portion 24 along the outer periphery of the shielded cable 11 and covered by the first extending portions 33 of the first crimp portion 31 and the second extending portion 38 of the second crimp portion 36 (see FIG. 8). At this time, a dimension in the circumferential direction of the first locking portion 34 on the back side is smaller than that of the first locking portion 34 on the front side and that of the second locking portion 39. In this way, the expansion deformation of the crimping portion 25 is prevented by the first and second locking portions 34, 39 facing the restricting portion 46 from the both circumferential sides.

In the already crimped state of the crimping portion 25, the biting projections 41 bite into the outer periphery of the sheath 17 at positions behind and very close to the sleeve 18 (see FIG. 2). By the biting of the biting projections 41 into the sheath 17, the crimping portion 25 is restricted from being relatively displaced in the circumferential direction and the axial direction with respect to the shielded cable 11.

As shown in FIG. 8, in the already crimped state of the crimping portion 25, the restricting portion 46 is covered by the first crimp portion 31 (first extending portions 33) and the second crimp portion 36 (second extending portion 38). A back end part of the first part 46A of the restricting portion 46 slightly projects further backward than the first locking portion 34 of the first crimp portion 31. The outer surface of the restricting portion 46 is arranged in contact with the inner periphery of the first crimp portion (first extending portions 33) and the inner periphery of the second crimp portion 36 (second extending portion 38). The pair of first locking portions 34 and the one second locking portion 39 are alternately arranged side by side in the axial direction of the shielded cable 11. The extension direction of the first extending portions 33 and that of the second extending portion 38 in the circumferential direction are opposite to each other, and the first and second locking portions 34, 39 are so arranged with respect to the restricting portion 46 as to sandwich the restricting portion 46 in the circumferential direction.

Here, a dimension of a part of the applicator where the crimping portion 25 and the shield connecting end part 19 are set is set to be large so that the crimping portion 25 and the shield connecting end part 19 having maximum dimensions within dimensional tolerances can be set. Thus, if the crimping portion 25 and the shield connecting end part 19 are set in the applicator, these may be set to be slightly shifted in the circumferential direction.

If the crimping step is performed with the crimping portion 25 and the shield connecting end part 19 set to be slightly shifted in the circumferential direction in the applicator, contact timings of the first and second extending portions 33, 38 with the restricting portion 46 may be shifted. Due to this timing shift, the restricting portion 46 may be possibly inclined in the circumferential direction with the base end thereof as a fulcrum.

For example, the two first extending portions 33 contact the restricting portion 46 earlier than the second extending portion 38. In this case, the restricting portion 46 is pressed rightward by the first extending portions 33 and inclined in a direction toward the base end of the second extending portion 38 with the base end of the pressing portion 46 as a fulcrum (see FIG. 9). Then, the crimping of the crimping portion 25 is completed with the restricting portion 46 kept inclined in the direction toward the base end of the second extending portion 38. A displacement amount of the restricting portion 46 inclined in the direction toward the base end of the second extending portion 38 increases from the front end toward the back end.

Here, in the circumferential direction, the end edge of the first part 46A on the side facing the first locking portions 34 (right side) is arranged to be stepped to approach the end edge on the side facing the second locking portion 39 with respect to the end edge of the second part 46B on the side facing the first locking portions 34 (left side). In the circumferential direction, the dimension of the first locking portion 34 of the first extending portion 33 on the back side is set to be smaller than that of the second locking portion 39. Thus, as shown in FIG. 9, even if the restricting portion 46 is inclined in the direction toward the base end of the second extending portion 38, the first locking surface 35 of the first locking portion 34 on the back side can be reliably set to face the right end edge of the first part 46A of the restricting portion 46.

Here, effects similar to the above are thought to be achieved even if the dimension of the first locking portion 34 of the first extending portion 33 on the back side is set to be equal to the dimension of the second locking portion 39 and the first extending portion 33 on the back side is made longer in the circumferential direction. However, if the crimping portion 35 thus configured is sandwiched by the crimper and the anvil, the tip of the first extending portion 33 on the back side collides with the end edge of the base plate portion 30 coupled to the base end of the second extending portion 38 and the first extending portion 33 may be buckled. Further, if the base plate portion 30 coupled to the base end of the second extending portion 38 is retracted away from the first extending portion 33 in the circumferential direction to avoid the buckling of the first extending portion 33, a function of the crimping portion 25 to be crimped to the shielded cable 11 may be lost. Thus, the dimension of the first locking portion 34 of the first extending portion 33 on the back side is preferably set to be smaller than that of the second locking portion 39.

Note that, if the second extending portion 38 contacts the restricting portion 46 earlier than the first extending portions 33 in the crimping step, the restricting portion 46 is inclined in a direction toward the base ends of the first extending portions 33 with the base end thereof as a fulcrum by being pressed leftward by the second extending portion 38 (not shown). The second part 46B is arranged closer to the base end of the restricting portion 46 than the first part 46A. Thus, a displacement amount of the second part 46B in the direction toward the base ends of the first extending portions 33 is smaller than that of the first part 46A in the direction toward the base ends of the first extending portions 33. Thus, if the restricting portion 46 is inclined in the direction toward the base ends of the first extending portions 33, the second locking portion 39 does not ride on the outer surface of the second part 46B.

Next, functions of this embodiment are described.

The wire-and-outer conductor crimping structure of the present disclosure is provided on the outer conductor 23 to be connected to the end part of the shielded cable 11 and provided with the crimping portion 25 in the form of an open barrel to be crimped to the outer periphery of the shielded cable 11. The crimping portion 25 includes the base plate portion 30, the first crimp portion 31, the second crimp portion 36, the first locking portions 34, the second locking portion 39 and the restricting portion 46. The base plate portion 30 is arranged along the outer periphery of the shielded cable 11. The first crimp portion 31 is cantilevered in the one circumferential direction of the shielded cable 11 from the base plate portion 30 and crimped to surround the outer periphery of the shielded cable 11. The second crimp portion 36 is cantilevered in the other circumferential direction from the position forward of the first crimp portion 31 in the base plate portion 30 and crimped to surround the outer periphery of the shielded cable 11.

The first locking portion 34 is provided by folding the tip part in the circumferential direction of the first crimp portion 31 inward. The second locking portion 39 is provided by folding the tip part in the circumferential direction of the second crimp portion 36 inward. The restricting portion 46 is cantilevered backward in the axial direction of the shielded cable 11 along the outer periphery of the shielded cable 11 and covered by the first and second crimp portions 31, 36. The second locking portion 39 is facing the end edge of the restricting portion 46 on the one circumferential side in the circumferential direction. The first locking portion 34 faces the end edge of the restricting portion 46 on the other circumferential side in the axial direction behind the second locking portion 39 in the axial direction. The width in the circumferential direction of the first part 46A facing the first locking portion 34, out of the restricting portion 46, is set to be smaller than that of the second part 46B facing the second locking portion 39, out of the restricting portion 46.

According to this configuration, a displacement of the restricting portion 46 is larger on the back side than on the front side. According to the present disclosure, the width in the circumferential direction of the first part 46A facing the first locking portion 34, out of the restricting portion 46, is set to be smaller than that of the second part 46B facing the second locking portion 39, out of the restricting portion 46. Thus, even if a back end part of the restricting portion 46 having a larger displacement amount than the front end is inclined in the direction toward the first locking portion 34, it is possible to prevent a situation where the first locking portion 34 rides on the restricting portion 46 and cannot lock.

In the circumferential direction, the end edge of the first part 46A on the side facing the first locking portion 34 is arranged to be stepped to approach the end edge on the side facing the second locking portion 39 with respect to the end edge of the second part 46B on the side facing the first locking portion 34. According to this configuration, even if the restricting portion 46 is inclined in the direction toward the first locking portion 34, the situation where the first locking portion 34 rides on the restricting portion 46 and cannot lock can be prevented by a simple configuration of forming the second part 46B and the first part 46A into a stepped shape.

The width W1 in the circumferential direction of the first part 46A is larger than half the width W2 in the circumferential direction of the second part 46B. According to this configuration, the strength of the first part 46A can be ensured and the deformation of this part can be prevented.

The back end part of the first part 46A projects further backward than the first locking portion 34. According to this configuration, since the first locking portion 34 can entirely face the end edge of the first part 46A in the axial direction, the first locking portion 34 can reliably lock the first part 46A.

In the circumferential direction, the dimension of the first locking portion 34 is smaller than that of the second locking portion 39. According to this configuration, a dimension between the first locking portion 46 and the first part 46A in the circumferential direction can be made larger than a dimension between the second locking portion 39 and the second part 46B in the circumferential direction. Thus, even if the restricting portion 46 is inclined in the direction toward the first locking portion 34, it is possible to prevent the situation where the first locking portion 34 rides on the restricting portion 46 and cannot lock.

### Other Embodiments

The present disclosure is not limited to the above described and illustrated embodiment. The present invention is intended to include all changes in the scope of claims and in the meaning and scope of equivalents and also include the following embodiments.
(1) Unlike the above embodiment, a formation range of the first locking portion in the axial direction may be only a part of the first extending portion. Further, a formation range of the second locking portion in the axial direction may be only a part of the second extending portion.
(2) Unlike the above embodiment, the numbers of the first and second locking portions alternately arranged in the axial direction may be a combination other than that of the embodiment (e.g. a combination of one first crimp portion and one second crimp portion or a combination of a pair of first locking portions and a pair of second locking portions).
(3) Unlike the above embodiment, only either one of the configuration for making the first locking portion on the back side shorter and the configuration for reducing the dimension in the circumferential direction of the first part may be adopted.
(4) Unlike the above embodiment, the first crimp portion, the second crimp portion and the restricting portion may be inverted in a lateral direction.

### LIST OF REFERENCE NUMERALS

10 . . . shield conductive path
11 . . . shielded cable (wire)
12 . . . coated wire
13 . . . insulation coating
14 . . . core wire
15 . . . insulator
16 . . . shield layer
17 . . . sheath
18 . . . sleeve
19 . . . shield connecting end part
20 . . . shield terminal
21 . . . inner conductor
22 . . . dielectric
23 . . . outer conductor
24 . . . shell body portion
25 . . . crimping portion
26 . . . upper shell
27 . . . upper body portion
28 . . . bottom plate portion
29 . . . side plate portion
30 . . . base plate portion
31 . . . first crimp portion
33 . . . first extending portion
34 . . . first locking portion
35 . . . first locking surface
36 . . . second crimp portion
38 . . . second extending portion
39 . . . second locking portion
40 . . . second locking surface
41 . . . biting projection
42 . . . lower shell
43 . . . lower body portion
44 . . . upper surface portion
45 . . . side surface portion
46 . . . restricting portion
46A . . . first part
46B . . . second part
47 . . . bottom surface portion
K . . . curved surface
W1 . . . width
W2 . . . width

1. A wire-and-outer conductor crimping structure, comprising a crimping portion in the form of an open barrel provided on an outer conductor to be connected to an end part of a wire, the crimping portion being crimped to an outer periphery of the wire,
the crimping portion including:
a base plate portion arranged along the outer periphery of the wire;
a first crimp portion cantilevered in one circumferential direction of the wire from the base plate portion, the first crimp portion being crimped to surround the outer periphery of the wire;
a second crimp portion cantilevered in the other circumferential direction from a position forward of the first crimp portion in the base plate portion, the second crimp portion being crimped to surround the outer periphery of the wire;
a first locking portion provided by folding a tip part in the circumferential direction of the first crimp portion inward;
a second locking portion provided by folding a tip part in the circumferential direction of the second crimp portion inward; and
a restricting portion cantilevered backward in an axial direction of the wire along the outer periphery of the wire, the restricting portion being covered by the first and second crimp portions,
the second locking portion facing an end edge of the restricting portion on one circumferential side in the circumferential direction,
the first locking portion facing an end edge of the restricting portion on the other circumferential side in the circumferential direction behind the second locking portion in the axial direction, and
a width in the circumferential direction of a first part facing the first locking portion, out of the restricting portion, being set to be smaller than a width in the circumferential direction of a second part facing the second locking portion, out of the restricting portion.

2. The wire-and-outer conductor crimping structure of claim 1, wherein an end edge of the first part on a side facing the first locking portion in the circumferential direction is arranged to be stepped to approach an end edge on a side facing the second locking portion with respect to an end edge of the second part on the side facing the first locking portion.

3. The wire-and-outer conductor crimping structure of claim 2, wherein the width in the circumferential direction of the first part is larger than half the width in the circumferential direction of the second part.

4. The wire-and-outer conductor crimping structure of claim 1, wherein a back end part of the first part projects further backward than the first locking portion.

5. The wire-and-outer conductor crimping structure of claim 1, wherein a dimension of the first locking portion is smaller than that of the second locking portion in the circumferential direction.

6. The wire-and-outer conductor crimping structure of claim 4, wherein a dimension of the first locking portion is smaller than that of the second locking portion in the circumferential direction.
